(19) United States
(12) Patent Application Publication
(10) Pub. No.: US 2006/0233370 A1
(43) Pub. Date: Oct. 19, 2006

(54) System and method for encryption processing in a mobile communication system

(75) Inventors: Jung-Soo Jung, Seongnam-si (KR); Beom-Sik Bae, Suwon-si (KR); Tae-Ho Kim, Suwon-si (KR); Dae-Gyun Kim, Seongnam-si (KR); Nae-Hyun Lim, Yongin-si (KR); Jae-Hong Chon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/406,349

(22) Filed: Apr. 19, 2006

(30) Foreign Application Priority Data
Apr. 19, 2005 (KR) 10-2005-0032530

(51) Int. Cl. H04K 1/00

(52) U.S. Cl. 380/247

(57) ABSTRACT

An encryption processing system and method are provided in a mobile communication system having an AT, an AN for sending packet data to the AT on a radio channel, a PCF for controlling the AN, and a PDSN for sending packet data to the AN through the PCF. The AT encrypts a packet generated upon user request and sends the encrypted packet on a radio channel. If it is indicated that the packet received from the AT was encrypted, the AN requests encryption information of the AT to the PCF and decrypts the encryption information received from the PCF. Upon receipt of the request of the encryption information of the AT from the AN, the PCF determines whether the AT is authenticated, extracts the encryption information of the AT if the AT is authenticated, and sends the extracted encryption information to the AN.

### CROSS-REFERENCE TO RELATED APPLICATIONS

This application claims the benefit under 35 U.S.C. §119(a) of Korean Patent Application No. 10-2005-0032530, entitled “System and Method for Encryption Processing in a Mobile Communication System”, filed in the Korean Intellectual Property Office on Apr. 19, 2005, the entire disclosure of which is herein incorporated by reference.

### BACKGROUND OF THE INVENTION

1. Field of the Invention

The present invention relates generally to an encryption system and method in a mobile communication system. In particular, the present invention relates to a system and method for encrypting user data and signaling messages prior to transmission in a mobile communication system.

2. Description of the Related Art

In general, mobile communication systems which provide circuit-based voice service use multiple access schemes, including Frequency Division Multiple Access (FDMA), Time Division Multiple Access (TDMA), and Code Division Multiple Access (CDMA). In FDMA, a frequency band is divided into several smaller channels and are allocated to subscribers. TDMA is an access scheme in which the same frequency channel is shared in time among a plurality of subscribers. CDMA enables a plurality of subscribers to use the same frequency band at the same time with different codes.

Along with the rapid development of communication technologies, the CDMA mobile communication system provides high-speed packet data service inclusive of a large amount of digital data such as e-mail, still images, and moving pictures, beyond the traditional voice service.

The 3^{rd} Generation (3G) mobile communication systems typically adopt CDMA to provide the high-speed packet data service. The U.S. has adopted synchronous CDMA, whereas Europe and Japan have chosen asynchronous CDMA. General Packet Radio Service (GPRS) is an asynchronous CDMA system, and CDMA2000 1x, 1xEvolution Data Only (EV-DO), and 1xEvolution Data and Voice (EV-DV), are synchronous CDMA systems. Synchronous International Mobile Telecommunication 2000 (IMT-2000) and asynchronous Universal Mobile Telecommunication System (UMTS) have been rapidly developed as future-generation mobile communication systems. UMTS is also called Wideband Code Division Multiple Access (WCDMA).

The above mobile communication systems will now each be described briefly. GPRS has evolved from circuit-based Global System for Mobile communication (GSM) in order to provide packet data service. CDMA 2000 1x provides data service at a downlink data rate of 144kbps, higher than the 14.4 kbps/56 kbps available in IS95A/IS95B, over an IS-95C network evolved from IS95A and IS95B networks. 1xEV-DO has been designed to provide a downlink data rate of about 2.4Mbps through one-level evolution from CDMA 2000 1x, aiming at transmission of a large amount of digital data. 1xEV-DV supports voice and data services simultaneously to overcome the shortcomings of 1xEV-DV which cannot provide the concurrent voice and data service.

Among them, 1xEV-DO is a major example having a channel configuration designed for high-speed data transmission. In 1xEV-DO, forward channels including a pilot channel, a forward Medium Access Control (MAC) channel, a forward traffic channel, and a forward control channel, are time-division-multiplexed. A set of time-division-multiplexed signals is called a burst.

The forward traffic channel carries a user data packet, and the forward control channel delivers a control message and a user data packet. The forward MAC channel is used to send reverse rate control and power control information or a channel designated for forward data transmission.

Unlike the forward channels, reverse channels for an Access Terminal (AT) have a terminal-specific identification code. The reverse channels include a pilot channel, a reverse traffic channel, an access channel, a Data Rate Control (DRC) channel, and a Reverse Rate Indicator (RRI) channel. The reverse traffic channel delivers a user data packet and the DRC channel indicates a forward data rate that the AT can support. The RRI channel is used to indicate the rate of a reverse data channel. The access channel sends a message or traffic from the AT to an Access Network (AN) before a traffic channel is established.

FIG. 1 is a block diagram of a typical 1xEV-DO system.

Referring to FIG. 1, the 1xEV-DO system comprises a Packet Data Service Node (PDSN) 40 connected to the Internet 50, for sending high-speed packet data to an AN 20, and a Packet Control Function (PCF) 30 for controlling the AN 20. The AN 20 wirelessly communicates with a plurality of ATs 10 and sends the high-speed packet data to an AT 10a having the highest data rate.

To guarantee highly secure transmission of user data and signaling messages between the ATs 10 and the AN 20, a transmitter encrypts the user data and signaling messages prior to transmission. The transmitter sends an authentication code together with the user data and signaling messages so that a receiver can identify the transmission from the transmitter.

To support the encryption and authentication, the ATs 10 and the AN 20 negotiate an encryption key and an authentication key on a channel basis during a session setup, and store them. When sending user data or a signaling message on a channel negotiated to be encrypted, the transmitter performs encryption using the encryption key and a cryptosync, forms a security layer packet with the encrypted packet and the cryptosync (whole or part), and sends the security layer packet to the receiver. The receiver decrypts the packet using the encryption key and the cryptosync set in the header of the packet.

When sending user data or a signaling message, the transmitter (MS or AN) can include an authentication code and a cryptosync in the header of a security layer packet to enable the receiver to verify that the authorized transmitter has transmitted. The authentication code can be created based on the negotiated authentication key of a channel, transmission data, a sector identification (ID), and a cryptosync. The receiver (e.g. PCF) compares an internally created authentication code with the authentication code set in the header. If they are identical, the receiver verifies that the authorized transmitter has sent the data.

FIG. 2 is a diagram illustrating a typical signal flow in the case where the AT sends a message together with an authentication code on an access channel and the authentication of the AT is successful in the AN.

Referring to FIG. 2, the AT 10 requests a call setup by sending a Connection Request message together with an authentication code on an access channel to the AN 20 in step 201. The Connection Request message includes a cryptosync. The AN 20 requests a data transmission path setup to the PCF 30 for data exchange between the PCF 30 and the AT 10 by sending an A9-Setup-A8 message in step 202. The A9-Setup-A8 message contains a security layer packet that the AN 20 has received from the AT 10.

The PCF 30 determines whether the AT 10 has sent the authentication code on the access channel, referring to its managed session information. If the AT 10 has sent the authentication code, the PCF 30 extracts the authentication code from the security layer packet sent together with the A9-Setup-A8 message, and determines whether the authentication code is valid based on the message part of the security layer packet, an authentication key for the AT 10 that the PCF 30 stored, the cryptosync in the security layer packet, and the ID of a sector that has received the packet. If the authentication code is valid, the PCF 30 requests a data transmission path for the AT 10 between the PCF 30 and the PDSN 40 by sending an A11-Registration Request message in step 203.

In step 204, the PDSN 40 sets up the data transmission path by sending an A11-Registration Reply message to the PCF 30. The PCF 30 notifies the AN 20 of the setup of the data transmission path by an A9-Connect-A8 message in step 205, and the AN 20 notifies the AT 10 of completion of the call setup by a Traffic Channel Assignment message in step 206. In step 207, a traffic channel is set up between the AT 10 and the AN 20. Then packet data transmission starts between the PDSN 40 and the AT 10 in step 208.

FIG. 3 is a diagram illustrating a typical signal flow in the case where the AT sends a message with an authentication code on the access channel and the mobile communication network fails to authenticate the AT.

Referring to FIG. 3, the AT 10 requests a call setup by sending a Connection Request message together with an authentication code on the access channel to the AN 20 in step 301. The Connection Request message includes a cryptosync. The AN 20 requests a data transmission path setup to the PCF 30 for data exchange between the PCF 30 and the AT 10 by sending an A9-Setup-A8 message in step 302. The A9-Setup-A8 message contains a security layer packet that the AN 20 has received from the AT 10. The PCF 30 determines whether the AT 10 has sent the authentication code on the access channel, referring to its managed session information.

If the AT 10 has sent the authentication code, the PCF 30 extracts the authentication code from the security layer packet in the A9-Setup-A8 message, and determines whether the authentication code is valid based on the message part of the security layer packet, an authentication key for the AT 10 that the PCF 30 stored, the cryptosync in the security layer packet, and the ID of a sector that has received the packet. If the authentication code is not valid, the PCF 30 notifies the AN 20 of the authentication failure by sending an A9-Release-A8 Complete message in step 303. In step 304, the AN 20 sends a Connection Deny message to the AT 10, notifying of the authentication failure. Thus, the call setup procedure is terminated.

To assist decryption and verification of an authentication code at the receiver, the AT 10 or the AN 20 sends a cryptosync along with encrypted user data, an encrypted message, or the authentication code. To distinguish a security layer packet type with a cryptosync from a security layer packet type without a cryptosync, the transmitter includes a security layer packet type indicator in the header of a MAC layer, a layer that delivers a security layer packet under the security layer.

Table 1 below illustrates by way of example, the structure of a packet header sent on the access channel.

Among the fields of the packet header, “SecurityLayerFormat” indicates whether a security layer packet sent on the access channel includes a cryptosync.

If the access channel packet is encrypted or includes an authentication code, the transmitter sets SecurityLayerFormat to 1 and includes a cryptosync in the packet. However, if the access channel packet is not encrypted and does not include an authentication code, the transmitter sets SecurityLayerFormat to 0.

TABLE 1

| Field | Length (bits) |
|---|---|
| Length | 8 |
| SessionConfigurationToken | 16 |
| SecurityLayerFormat | 1 |
| ConnectionLayerFormat | 1 |
| Reserved | 4 |
| ATI Record | 34 |

When receiving a packet on a particular channel, the AT 10 and the AN 20 determine whether the channel was encrypted. If the channel was encrypted, the encrypted packet is decrypted and an operation corresponding to the packet is performed. Here, the AT 10 and the AN 20 need to determine whether encryption was used or not.

If encryption was used, a key and other information for decryption are needed. The AT 10 stores all information required for communications in hardware and thus, it can acquire the information directly. For the AN 20, session information is stored in a Session Control/Mobility Management (SC/MM) of the PCF 30. Therefore, the AN 20 has to acquire the information, for decryption. However, there is no specified procedure in which the AN 20 receives encryption information from the PCF 30 and thus it is impossible to acquire the encryption information.

Moreover, there is no way to indicate whether a packet transmitted or received on a particular channel has been encrypted or not in the conventional EV-DO system. Accordingly, the AN has to make a decision as to whether packets received on channels are encrypted or not.

Accordingly, a need exists for a system and method for indicating whether a packet transmitted/received on a particular channel was encrypted.

### SUMMARY OF THE INVENTION

An object of embodiments of the present invention is to substantially solve at least the above problems and/or disadvantages, and to provide at least the advantages below. Accordingly, embodiments of the present invention provide a system and method for indicating whether a packet transmitted/received on a particular channel was encrypted in a mobile communication system.

Embodiments of the present invention provide a system and method for enabling transmission/reception of encryption information between an AN and a PCF in a mobile communication system.

Embodiments of the present invention also provide a system and method for determining whether a packet was encrypted from a bit, indicating whether encryption was performed, added to a MAC layer header.

Embodiments of the present invention also provide a system and method for enabling exchange of encryption information between an AN and a PCF so that the AN can acquire the encryption information from the PCF.

According to one aspect of embodiments of the present invention, an encryption processing system is provided in a mobile communication system comprising an AT, an AN for sending packet data to the AT on a radio channel, a PCF for controlling the AN, and a PDSN for sending packet data to the AN through the PCF. The AT encrypts a packet generated upon user request and sends the encrypted packet on a radio channel. If it is indicated that the packet received from the AT was encrypted, the AN requests encryption information of the AT to the PCF and decrypts the encryption information received from the PCF. Upon receipt of the request of the encryption information of the AT from the AN, the PCF determines whether the AT is authenticated, extracts the encryption information of the AT if the AT is authenticated, and sends the extracted encryption information to the AN.

According to another aspect of embodiments of the present invention, an encryption processing method is provided in a mobile communication system comprising an AT, an AN for sending packet data to the AT on a radio channel, a PCF for controlling the AN, and a PDSN for sending packet data to the AN through the PCF. The method comprises steps, such that a packet generated upon user request is encrypted and sent on a radio channel to the AN by the AT. If it is indicated that the packet received from the AT was encrypted, encryption information of the AT is requested to the PCF by the AN. It is determined whether the AT is authenticated by the PCF, upon receipt of the request of the encryption information of the AT from the AN. If the AT is authenticated, the encryption information of the AT is extracted and sent to the AN by the PCF. The encryption information received from the PCF is decrypted by the AN.

According to another aspect of embodiments of the present invention, an encryption processing apparatus is provided in an AT in a mobile communication system comprising the AT, an AN for sending packet data to the AT on a radio channel, a PCF for controlling the AN, a PDSN for sending packet data to the AN through the PCF, and a message generator for generating a packet upon user request. The apparatus can further comprise an encrypter for encrypting the packet, and a transmitter for sending the encrypted packet to a receiver on a radio channel.

According to still another aspect of embodiments of the present invention, an encryption processing method is provided in an AT in a mobile communication system comprising the AT, an AN for sending packet data to the AT on a radio channel, a PCF for controlling the AN, and a PDSN for sending packet data to the AN through the PCF. The method comprises steps such that, upon user request, a packet is generated, encrypted, and sent to a receiver on a radio channel.

According to yet another aspect of embodiments of the present invention, an encryption processing apparatus is provided in an AN in a mobile communication system comprising an AT, the AN for sending packet data to the AT on a radio channel, a PCF for controlling the AN, a PDSN for sending packet data to the AN through the PCF, an RF processor for receiving a packet from the AT on a radio channel, a controller for determining whether the packet was encrypted and requesting encryption information of the AT to the PCF if the packet was encrypted, and a decrypter for decrypting the encryption information of the AT received from the PCF.

According to yet another aspect of embodiments of the present invention, an encryption processing method is provided in an AN in a mobile communication system comprising an AT, the AN for sending packet data to the AT on a radio channel, a PCF for controlling the AN, and a PDSN for sending packet data to the AN through the PCF. The method comprises steps, such that a packet is received from the AT on a radio channel. It is determined whether the packet was encrypted. If the packet was encrypted, encryption information of the AT is requested to the PCF. The encryption information of the AT received from the PCF is decrypted.

According to still another aspect of embodiments of the present invention, an encryption processing apparatus is provided in a PCF in a mobile communication system comprising an AT, an AN for sending packet data to the AT on a radio channel, the PCF for controlling the AN, a PDSN for sending packet data to the AN through the PCF, an SC/MM for storing encryption information and session information of an authenticated AT, and a controller for, upon receipt of a request of encryption information of the AT from the AN, determining whether the AT is authenticated, extracting the encryption information of the AT from the SC/MM if the AT is authenticated, and sending the extracted encryption information to the AN.

According to still another aspect of embodiments of the present invention, an encryption processing method is provided in a PCF in a mobile communication system comprising an AT, an AN for sending packet data to the AT on a radio channel, the PCF for controlling the AN, and a PDSN for sending packet data to the AN through the PCF. The method comprises steps, such that upon receipt of a request of encryption information of the AT from the AN, it is determined whether the AT is authenticated. If the AT is authenticated, the encryption information of the AT is extracted from an SC/MM and sent to the AN.

### BRIEF DESCRIPTION OF THE DRAWINGS

The above and other objects, features and advantages of embodiments of the present invention will become more apparent from the following detailed description when taken in conjunction with the accompanying drawings in which:

FIG. 1 is a block diagram of a typical 1xEv-DO system;

FIG. 2 is a diagram illustrating a typical signal flow in the case where an AT sends a message together with an authentication code on an access channel and a mobile communication network succeeds in authenticating the AT;

FIG. 3 is a diagram illustrating a typical signal flow in the case where the AT sends a message with an authentication code on the access channel and the mobile communication network fails to authenticate the AT;

FIG. 4 is a block diagram of an exemplary mobile communication system for encryption processing according to an embodiment of the present invention;

FIG. 5 is a flowchart illustrating an exemplary encryption processing method in a mobile communication system according to an embodiment of the present invention;

FIGS. 6A and 6B illustrate a structure of an exemplary A14-EncryptionInfo Request message proposed for encryption in a mobile communication system according to an embodiment of the present invention; and

FIGS. 7A and 7B illustrate a structure of an exemplary A14-EncryptionInfo Response message proposed for encryption in a mobile communication system according to an embodiment of the present invention.

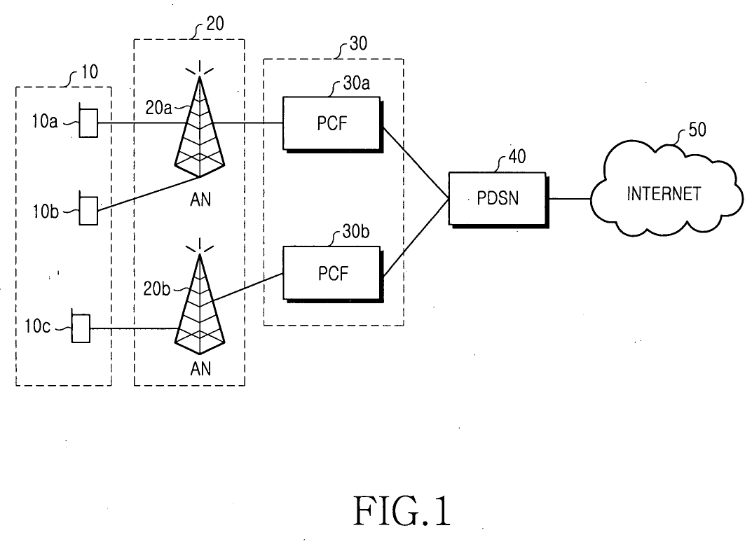

Throughout the drawings, like reference numerals will be understood to refer to like parts, components and structures.

### DETAILED DESCRIPTION OF THE EXEMPLARY EMBODIMENTS

Exemplary embodiments of the present invention will be described herein below with reference to the accompanying drawings. In the following description, well-known functions or constructions are not described in detail since they would obscure the invention in unnecessary detail.

Embodiments of the present invention are intended to provide a system and method for indicating whether a transmitted/received packet was encrypted in order to reduce unnecessary message transmission/reception between an AN and a PCF in a mobile communication system.

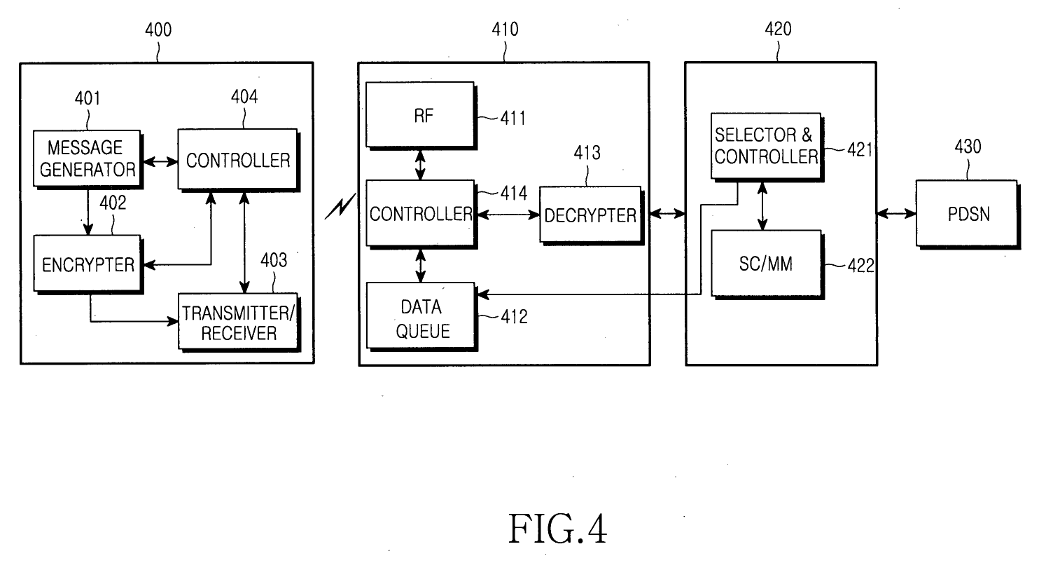

FIG. 4 is a block diagram of an exemplary mobile communication system for encryption processing according to an embodiment of the present invention.

Referring to FIG. 4, the encryption processing system comprises an AT 400, an AN 410, a PCF 420, and a PDSN 430.

The AT 400 is comprised of a message generator 401 for generating user data and signaling messages upon user request, an encrypter 402 for encrypting messages, a transmitter/receiver 403 for transmitting/receiving encrypted messages to/from the AN 410, and a controller 404 for providing overall control to the AT 400 so that the message generator 401, the encrypter 402, and the transmitter/receiver 403 can operate according to an embodiment of the present invention.

In the message generator 401, upon receipt of data, a demodulator (not shown) demodulates the received signal, a decoder (not shown) decodes the demodulated signal, and the controller 404 judges and processes the reception result. For transmission, an encoder (not shown) encodes a transmission signal and a modulator (not shown) modulates the encoded signal, thereby generating a message.

The encrypter 402 encrypts the message generated from the message generator 401 and indicates that the message was encrypted in the MAC layer headers of an access channel and a forward control channel, which will be described in greater detail below with reference to Table 2 and Table 3.

The transmitter/receiver 403 sends the encrypted message to the AN 410 on a radio channel.

The AN 410 comprises a Radio Frequency (RF) processor 411, a data queue 412, a decrypter 413, and a controller 414.

The RF processor 411 receives a packet on the access channel. The data queue 412 stores the packet received from the RF processor 411. The decrypter 413, upon receipt of encryption information of the AT 400 from the PCF 420, decrypts the encryption information.

The controller 414 provides overall control to the AN 410 so that the RF processor 411, the decrypter 413, and the data queue 412 operate according to an embodiment of the present invention. If it is indicated that a packet received through the RF processor 411 was encrypted, the controller 414 requests encryption information of the AT 400 to the PCF 420.

The data queue 412 stores data received from the PCF 420 by AT and by service. The controller 414 selects data for a particular AT from a particular queue, taking into account the amount of data in each queue, the channel statuses of ATs, service characteristics, fairness, and so forth.

The PCF 420 comprises a selector and controller 421, and an SC/MM 422.

Upon receipt of the message requesting the encryption information of the AT 400, the selector and controller 421 determines whether the AT 400 is authenticated. If the AT 400 is authenticated, the selector and controller 421 extracts encryption information. It also maintains and updates session information in the SC/MM 422 by messages transmitted/received to/from the AT 400.

The SC/MM 422 stores the encryption information and session information of the authenticated AT. The encryption information contains a key for decryption in the AN and other decryption information.

The PCF 420 sends user data received from the PDSN 430 to the AN 410 which covers the AT 400.

The PDSN 430 sends packet data to the AN 410 through the PCF 420.

In the mobile communication system, the AN has to determine for every packet received on each channel, whether the packet was encrypted. To reduce overhead, embodiments of the present invention propose a system and method of indicating whether a packet transmitted/received on a channel was encrypted.

Table 2 below illustrates by way of example, the structure of a MAC layer header for the access channel to indicate whether encryption was performed in accordance with embodiments of the present invention. For example, 1 bit of a conventional 4-bit Reserved field is defined as a new EncryptionApplied field that indicates whether encryption was performed or not. When sending a packet on the access channel, the AT sets the EncryptionApplied field to 1 if the packet is encrypted and the EncryptionApplied field to 0 if the packet is not encrypted.

TABLE 2

| Field | Length (bits) |
|---|---|
| Length | 8 |
| SessionConfigurationToken | 16 |
| SecurityLayerFormat | 1 |
| ConnectionLayerFormat | 1 |
| EncryptionApplied | 1 |
| Reserved | 3 |
| ATI Record | 34 |

Upon receipt of the packet from the AT 400 on the access channel, the AN 410 determines whether to decrypt the packet from the EncryptionApplied field of the MAC layer header.

TABLE 3

| Field | Length (bits) |
|---|---|
| Length | 8 |
| SecurityLayerFormat | 1 |
| ConnectionLayerFormat | 1 |
| EncryptionApplied | 1 |
| Reserved | 3 |
| ATI Record | 2 or 34 |

Table 3 illustrates by way of example, the structure of a MAC layer header for the forward control channel to indicate whether encryption was performed in accordance with embodiments of the present invention. For example, 1 bit of a conventional 4-bit Reserved field is defined as a new EncryptionApplied field that indicates whether encryption was performed or not. When sending a packet on the forward control channel, the AN 410 sets the EncryptionApplied field to 1 if the packet is encrypted and the EncryptionApplied field to 0 if the packet is not encrypted.

Upon receipt of the packet from the AN 410 on the forward control channel, the AT 400 determines whether to decrypt the packet from the EncryptionApplied field of the MAC layer header.

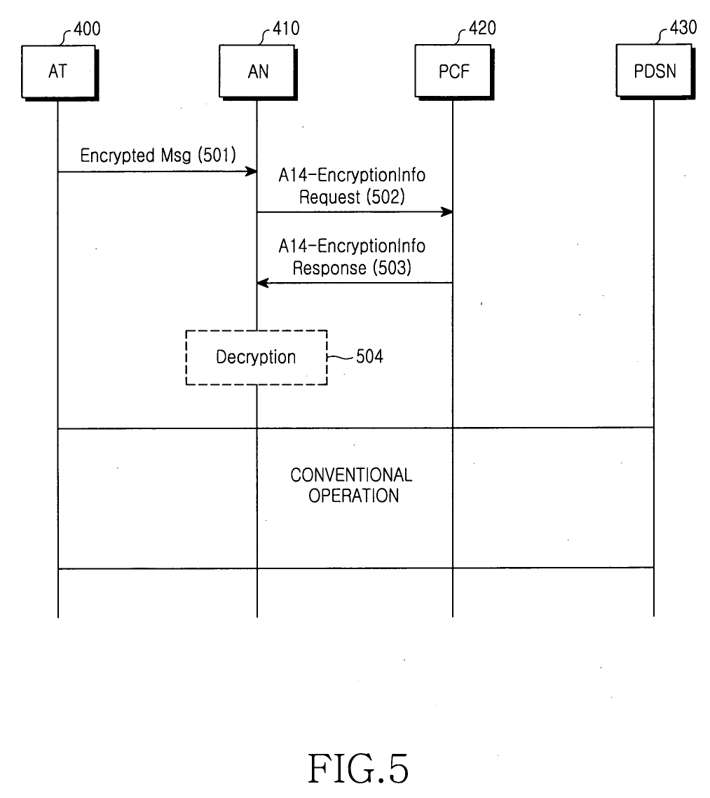

FIG. 5 is a flowchart illustrating an exemplary encryption processing method in the mobile communication system according to an embodiment of the present invention. Referring to FIG. 5, a description will be made of a novel method of enabling transmission/reception of encryption information between the AN and the PCF.

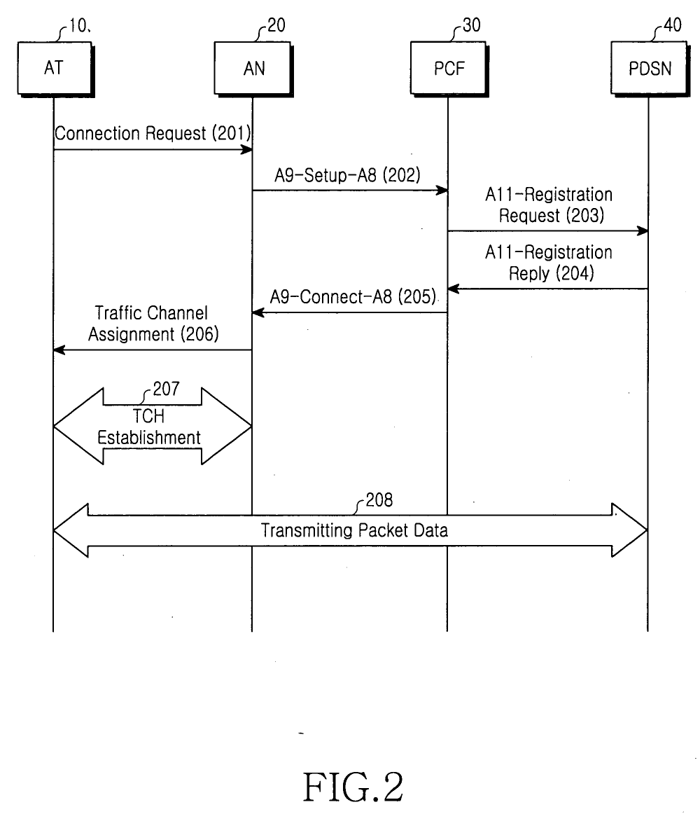

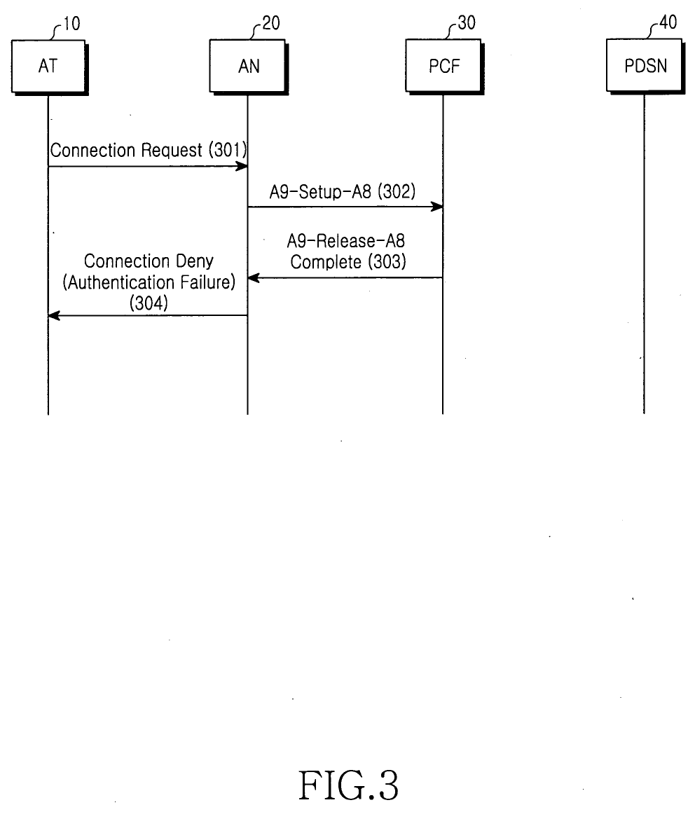

Referring to FIG. 5, the AN 410 receives an encrypted message from the AT 400 on the access channel in step 501. If the EncryptionApplied field of the message is set to 1, the AN 410 considers that the message was encrypted. In step 502, the AN 410 requests encryption information of the AT 400 to the PCF 420 by an A14-Encryptionlnfo Request message according to embodiments of the present invention. The A14-Encryptionlnfo Request message comprises the ID of the AT 400 set in the MAC layer header of the received packet and the security layer packet included in the received packet. The PCF 420 can check whether the authenticated AT has sent the security layer packet. The authentication will not be described herein. The check is described above in regard to step 203 of FIG. 2.

If an authenticated AT 400 has sent the packet, the PCF 420 extracts the encryption information of the AT 400 from the SC/MM 422 and sends an A14-EncryptionInfo Response message with the encryption information to the AN 410 in step 503. In step 504, the AN 410 decrypts the packet based on the received encryption information. Thus, the AN 410 determine information about the received packet. After step 504, the AN 410 performs an operation corresponding to the packet.

However, if the packet is from a non-authenticated AT 400 in step 503, the PCF 420 sends an A14-Encryptionlnfo Response message to the AN 410, notifying of authentication failure. The subsequent operation cannot be performed.

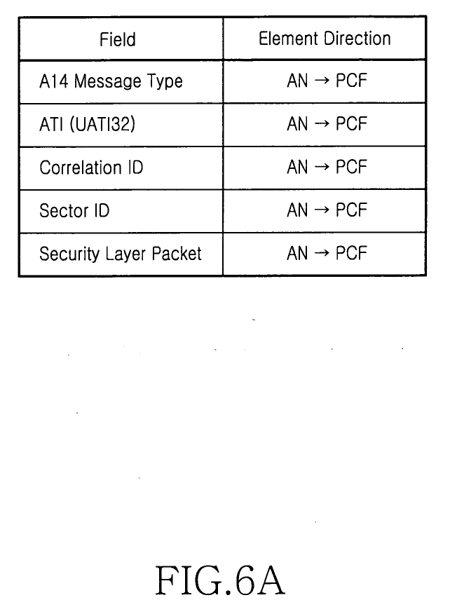

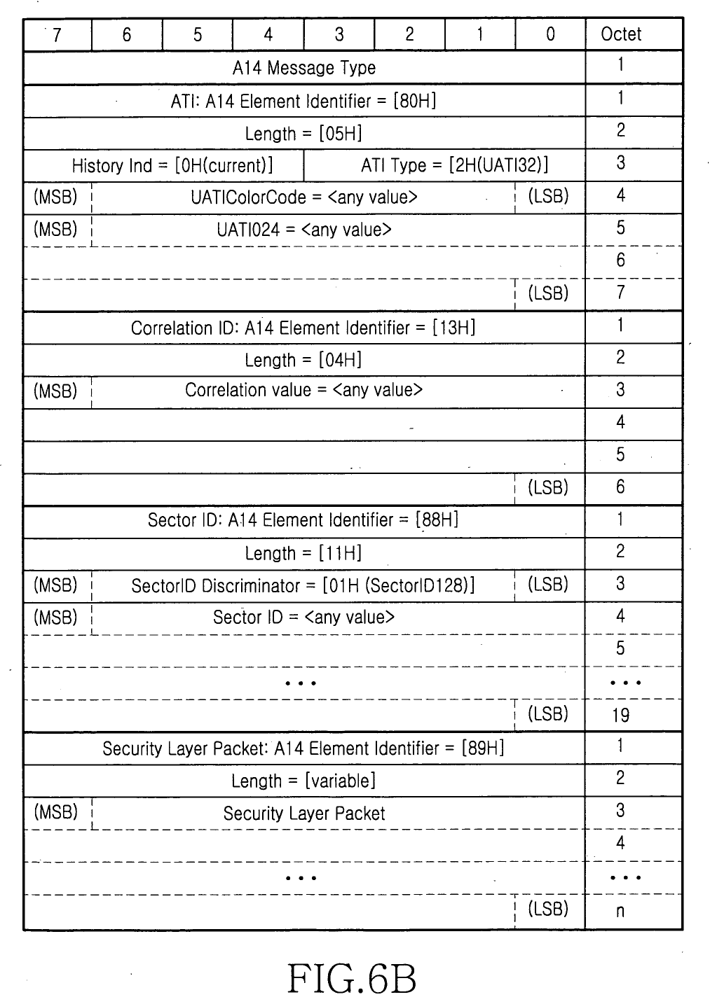

FIGS. 6A and 6B illustrate a structure of an exemplary A14-Encryptionlnfo Request message (for example, as shown at step 502 of FIG. 5) proposed for encryption in the mobile communication system according to an embodiment of the present invention.

Referring to FIG. 6A, an exemplary A14-Encryptionlnfo Request message comprises the information elements of A14 Message Type indicating the message type of the A14-Encryptionlnfo Request message, Access Terminal Identifier (ATI) representing the address of the AT, Correlation ID used to distinguish different A14-Encryptionlnfo Request messages, Sector ID identifying the AN that has sent the A14-Encryptionlnfo Request message, and Security Layer Packet containing the received security layer packet. These information elements are preferably sent from the AN 410 to the PCF 420.

FIG. 6B illustrates the A14-Encryptionlnfo Request message in the form of a bitmap.

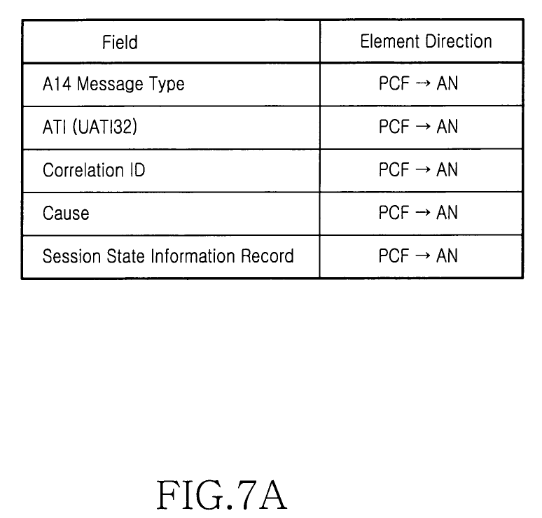

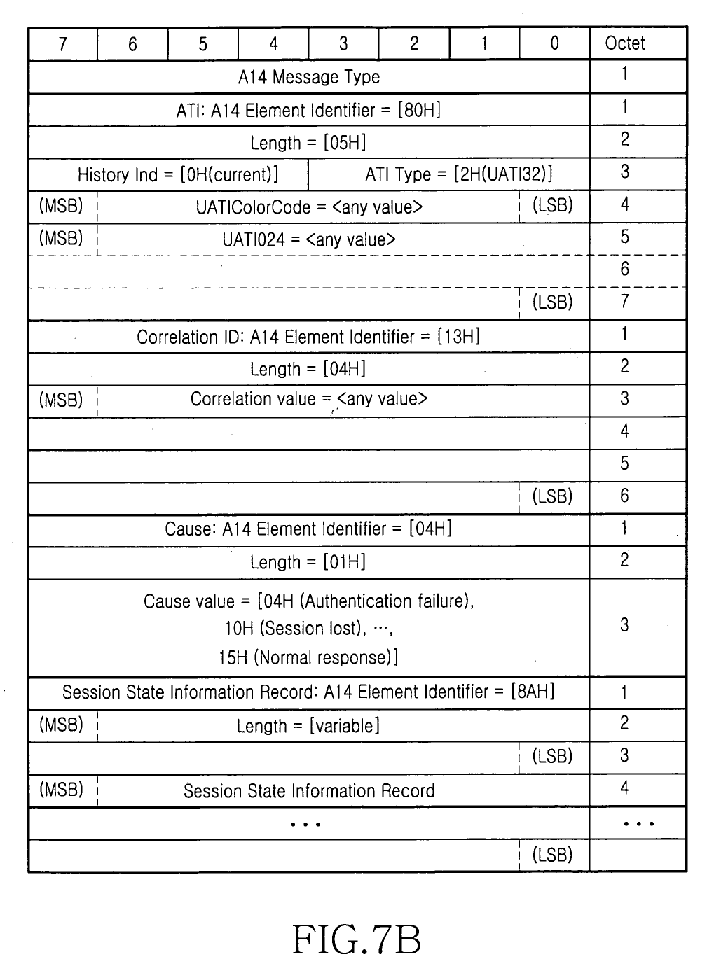

FIGS. 7A and 7B illustrate a structure of an exemplary A14-EncryptionInfo Response message (for example, as shown at step 503 of FIG. 5) proposed for encryption in the mobile communication system according to an embodiment of the present invention.

Referring to FIG. 7A, an exemplary A14-Encryptionlnfo Response message comprises the information elements of A14 Message Type indicating the message type of the A14-Encryptionlnfo Response message, ATI representing the address of the AT, Correlation ID identifying the A14-Encryptionlnfo Request message for which the A14-Encryptionlnfo Response message is created, Cause indicating the type of the response, and Session State Information Record providing the encryption information and other session information of the AT. Here, the Correlation ID is substantially identical to the Correlation ID of the A14-Encryptionlnfo Response message. These information elements are preferably sent from the PCF 420 to the AN 410.

FIG. 7B illustrates the A14-Encryptionlnfo Response message in the form of a bitmap.

In accordance with embodiments of the present invention as described above, since it is indicated whether a packet transmitted/received on a channel was encrypted, overhead resulting from determining for every packet received on each channel whether encryption was performed, can be reduced. Also, encryption information can be transmitted/received between an AN and a PCF, so that the AN can acquire the encryption information from the PCF.

While the invention has been shown and described with reference to certain exemplary embodiments thereof, it will be understood by those skilled in the art that various changes in form and details may be made therein without departing from the spirit and scope of the invention as defined by the appended claims.

1. An encryption processing system in a mobile communication system, comprising:
an access terminal (AT), for encrypting a packet and sending the encrypted packet on a radio channel;
an access network (AN) for receiving packet data from the AT on a radio channel and, if it is indicated that the packet received from the AT was encrypted, requesting encryption information of the AT to a PCF and decrypting the encrypted packet received from the AT based on encryption information received from the PCF;
a packet control function (PCF) for controlling the AN and, upon receipt of the request of the encryption information of the AT from the AN, determining whether the AT is authenticated, extracting the encryption information of the AT if the AT is authenticated, and sending the extracted encryption information to the AN; and
a packet data service node (PDSN) for sending packet data to the AN through the PCF

2. The encryption processing system of claim 1, wherein the packet is generated upon user request in AT.

3. The encryption processing system of claim 1, wherein the AT is configured to indicate whether the packet was encrypted in an EncryptionApplied field of a medium access control (MAC) layer header of an access channel, after the encryption.

4. The encryption processing system of claim 1, wherein the information sent from the AN to the PCF comprises:
an access terminal identifier (ATI) field for indicating a address of the AT.

5. The encryption processing system of claim 4, wherein the information sent from the AN to the PCF further comprises:
an A-Message Type field for indicating a message type;
a Correlation ID field for distinguishing different A14-EncryptionInfo Request messages;
a Sector ID field for identifying the AN that sends an A14-EncryptionInfo Request message; and
a Security Layer Packet field for containing a received security layer packet.

6. The encryption processing system of claim 1, wherein the encryption information comprises an encryption key and decryption information, for decryption in the AN.

7. An encryption processing method in a mobile communication system comprising an access terminal (AT), an access network (AN) for sending packet data to the AT on a radio channel, a packet control function (PCF) for controlling the AN, and a packet data service node (PDSN) for sending packet data to the AN through the PCF, comprising the steps of:
encrypting a packet and sending the encrypted packet on a radio channel to the AN by the AT;
requesting encryption information of the AT to the PCF by the AN, if it is indicated that the packet received from the AT was encrypted;
determining whether the AT is authenticated and upon receipt of the request of the encryption information of the AT from the AN, extracting the encryption information of the AT if the AT is authenticated, and sending the extracted encryption information to the AN by the PCF; and
decrypting the encrypted packet received from the AT based on the encryption information received from the PCF by the AN.

8. The encryption processing method of claim 7, wherein the packet is generated upon user request in AT.

9. The encryption processing method of claim 7, further comprising the step of:
indicating whether the packet was encrypted in an EncryptionApplied field of a medium access control (MAC) layer header of an access channel by the AT, after the encryption.

10. The encryption processing method of claim 7, wherein the information sent from the AN to the PCF comprises:
an access terminal identifier (ATI) field for indicating a address of the AT.

11. The encryption processing method of claim 10, wherein the information sent from the AN to the PCF further comprises:
an A14 Message Type field for indicating a message type;
a Correlation ID field for distinguishing different A14-Encryptionlnfo Request messages;
a Sector ID field for identifying the AN that sends an A14-EncryptionInfo Request message; and
a Security Layer Packet field for containing a received security layer packet.

12. The encryption processing method of claim 7, wherein the encryption information comprises an encryption key and decryption information, for decryption in the AN.

13. An encryption processing apparatus in an access terminal (AT) in a mobile communication system comprising the AT, an access network (AN) for sending packet data to the AT on a radio channel, a packet control function (PCF) for controlling the AN, and a packet data service node (PDSN) for sending packet data to the AN through the PCF, comprising:
a message generator for generating a packet;
an encrypter for encrypting the packet; and
a transmitter for sending the encrypted packet to a receiver on a radio channel wherein the encrypter is configured to indicate whether the packet was encrypted.

14. The encryption processing apparatus of claim 13, wherein the encrypter is configured to indicate whether the packet was encrypted in an EncryptionApplied field of a medium access control (MAC) layer header of an access channel, after the encryption.

15. The encryption processing apparatus of claim 13, wherein the encrypter is configured to indicate whether the packet was encrypted in an EncryptionApplied field of a MAC layer header of a forward control channel, after the encryption.

16. An encryption processing method in an access terminal (AT) in a mobile communication system comprising the AT, an access network (AN) for sending packet data to the AT on a radio channel, a packet control function (PCF) for controlling the AN, and a packet data service node (PDSN) for sending packet data to the AN through the PCF, comprising the steps of:
generating a packet upon user request;
encrypting the packet;
indicating whether the packet was encrypted; and
sending the encrypted packet to a receiver on a radio channel.

17. The encryption processing method of claim 16, wherein the step of indicating whether the packet was encrypted:
it is indicated in an EncryptionApplied field of a medium access control (MAC) layer header of an access channel, after the encryption.

18. The encryption processing method of claim 16, wherein the step of indicating whether the packet was encrypted:
it is indicated in an EncryptionApplied field of a MAC layer header of a forward control channel, after the encryption.

19. An encryption processing apparatus in an access network (AN) in a mobile communication system comprising an access terminal (AT), the AN for sending packet data to the AT on a radio channel, a packet control function (PCF) for controlling the AN, and a packet data service node (PDSN) for sending packet data to the AN through the PCF, comprising:
a radio frequency (RF) processor for receiving a packet from the AT on a radio channel;
a controller for determining whether the packet was encrypted, and requesting encryption information of the AT to the PCF, if the packet was encrypted; and
a decrypter for decrypting the encrypted packet received from the AT based on the encryption information of the AT received from the PCF.

20. The encryption processing apparatus of claim 19, wherein the controller is configured to determine whether the packet was encrypted from an EncryptionApplied field of a medium access control (MAC) layer header of an access channel.

21. The encryption processing apparatus of claim 19, wherein the controller is configured to determine whether the packet was encrypted from an EncryptionApplied field of a MAC layer header of a forward control channel.

22. The encryption processing apparatus of claim 19, wherein the information sent from the AN to the PCF comprises:
an access terminal identifier (ATI) field for indicating a address of the AT.

23. The encryption processing apparatus of claim 22, wherein the information sent from the AN to the PCF further comprises:
an A-Message Type field for indicating a message type;
a Correlation ID field for distinguishing different A14-Encryptionlnfo Request messages;
a Sector ID field for identifying the AN that sends an A14-Encryptionlnfo Request message; and
a Security Layer Packet field for containing a received security layer packet.

24. The encryption processing apparatus of claim 19, wherein the encryption information comprises an encryption key and decryption information, for decryption in the AN.

25. An encryption processing method in an access network (AN) in a mobile communication system comprising an access terminal (AT), the AN for sending packet data to the AT on a radio channel, a packet control function (PCF) for controlling the AN, and a packet data service node (PDSN) for sending packet data to the AN through the PCF, comprising the steps of:
receiving a packet from the AT on a radio channel;
determining whether the packet was encrypted;
requesting encryption information of the AT to the PCF, if the packet was encrypted; and
decrypting the encrypted packet received from the AT based on the encryption information of the AT received from the PCF.

26. The encryption processing method of claim 25, wherein the determination step comprises the step of:
determining whether the packet was encrypted from an EncryptionApplied field of a medium access control (MAC) layer header of an access channel.

27. The encryption processing method of claim 25, wherein the determination step comprises the step of:
determining whether the packet was encrypted from an EncryptionApplied field of a MAC layer header of a forward control channel.

28. The encryption processing method of claim 25, wherein the information sent from the AN to the PCF comprises:
an access terminal identifier (ATI) field for indicating a address of the AT.

29. The encryption processing method of claim 28, wherein the information sent from the AN to the PCF further comprises:
an A14 Message Type field for indicating a message type;
a Correlation ID field for distinguishing different A14-Encryptionlnfo Request messages;
a Sector ID field for identifying the AN that sends an A14-Encryptionlnfo Request message; and
a Security Layer Packet field for containing a received security layer packet.

30. The encryption processing method of claim 25, wherein the encryption information comprises an encryption key and decryption information, for decryption in the AN.

31. An encryption processing apparatus in a packet control function (PCF) in a mobile communication system comprising an access terminal (AT), an access network (AN) for sending packet data to the AT on a radio channel, the PCF for controlling the AN, and a packet data service node (PDSN) for sending packet data to the AN through the PCF, comprising:
a session controller and mobility manager (SC/MM) for storing encryption information and session information of an authenticated AT; and
a controller for, upon receipt of a request of encryption information of the AT from the AN, determining whether the AT is authenticated, extracting the encryption information of the AT from the SC/MM, if the AT is authenticated, and sending the extracted encryption information to the AN.

32. The encryption processing apparatus of claim 31, wherein the information sent from the AN to the PCF comprises:
an A14 Message Type field for indicating a message type;
an access terminal identifier (ATI) field for indicating a address of the AT; and
a Correlation identifier (ID) field for distinguishing different A14-Encryptionlnfo Request messages:
a Sector ID field for identifying the AN that sends an A14-Encryptionlnfo Request message; and
a Security Layer Packet field for containing a received security layer packet.

33. The encryption processing apparatus of claim 31, wherein the information sent from the PCF to the AN comprises:
an A14 Message Type field for indicating a message type;
an ATI field for indicating a address of the AT;
a Correlation ID field for identifying a A14-Encryptionlnfo Request message for which a A14-Encryptionlnfo Response message is created;
a Cause field for indicating a type of a response; and
a Session State Information Record field for providing the encryption information and other session information of the AT.

34. The encryption processing apparatus of claim 31, wherein the encryption information comprises an encryption key and decryption information, for decryption in the AN.

35. An encryption processing method in a packet control function (PCF) in a mobile communication system comprising an access terminal (AT), an access network (AN) for sending packet data to the AT on a radio channel, the PCF for controlling the AN, and a packet data service node (PDSN) for sending packet data to the AN through the PCF, comprising the steps of:
determining whether the AT is authenticated, upon receipt of a request of encryption information of the AT from the AN; and
extracting the encryption information of the AT from a session controller and mobility manager (SC/MM), if the AT is authenticated, and sending the extracted encryption information to the AN.

36. The encryption processing method of claim 35, further comprising the step of storing the encryption information and session information of the authenticated AT.

37. The encryption processing method of claim 35, wherein the information sent from the AN to the PCF comprises:
an A14 Message Type field for indicating a message type;
an access terminal identifier (ATI) field for indicating a address of the AT;
a Correlation identifier (ID) field for distinguishing different A14-EncryptionInfo Request messages.
a Sector ID field for identifying the AN that sends an A14-Encryptionilnfo Request message; and
a Security Layer Packet field for containing a received security layer packet.

38. The encryption processing method of claim 35, wherein the information sent from the PCF to the AN comprises:
an A14 Message Type field for indicating a message type;
an ATI field for indicating a address of the AT;
a Correlation ID field for identifying a A14-Encryptioninfo Request message for which a A14-Encryptionlnfo Response message is created;
a Cause field for indicating a type of a response; and
a Session State Information Record field for providing the encryption information and other session information of the AT.

39. The encryption processing method of claim 35, wherein the encryption information comprises an encryption key and decryption information, for decryption in the AN.
